(19) United States
(12) Patent Application Publication
(10) Pub. No.: US 2008/0319776 A1
(43) Pub. Date: Dec. 25, 2008

(54) Systems and methods for extending a patent monopoly on an active ingredient for a chemical composition and on the chemical composition having the active ingredient

(76) Inventor: Gil Tomer, Tel-Aviv (IL)

Correspondence Address: Factor - Patent Attorneys, 11 Amal Street, Afek TECHNOLOGY Park, Rosh HA' AYIN, 46092, IL

(21) Appl. No.: 11/819,012

(22) Filed: Jun. 25, 2007

(51) Int. Cl. G06Q 10/00

(52) U.S. Cl. 705/1

(57) ABSTRACT

A system and method are provided for extending the period of traditional patent protection. Initially, the developer develops an active ingredient for a chemical composition and/or the chemical composition having the active ingredient. An initial patent application is then filed in a selected country on behalf of the developer of the active ingredient and/or the composition having the active ingredient, such application being directed to the active ingredient and/or the composition having the active ingredient, and an initial certificate of patent grant on the active ingredient and/or composition having the active ingredient is obtained. Limited data relating to the active ingredient and/or the composition having the active ingredient is released by the developer, such data being the only publicly available data on the active ingredient and/or the composition having the active ingredient. Next, at least a first time interval during the product life of the active ingredient and/or the composition having the active ingredient is identified. The first interval commences upon submission of the initial application directed to protection of the active ingredient and/or the composition having the active ingredient and ends on the date that authorization is obtained from one of a group of government related regulatory authorities for marketing the active ingredient and/or the composition having the active ingredient. Thereafter, at least a second time interval during the product life of the active ingredient and/or the composition having the active ingredient is identified. The second interval begins on the date that initial marketing of the active ingredient and/or the composition having the active ingredient commenced and ends upon expiration of the certificate of patent grant. Finally, before the end of either of the first and second time intervals, a subsequent patent application is filed on behalf of the developer in the same country as the initial application, the subsequent application being based on the initial application, having subject matter in common with the initial application, and having continuity of filing with respect to the initial application. The subsequent application is directed to newly appreciated properties or characteristics of the active ingredient and/or the composition having the active ingredient. Finally, a subsequent certificate of patent grant is then obtained on the subsequent application, thereby lawfully interfering with the production and marketing of such active ingredient and/or composition having the active ingredient by the one or more third party developers.

### FIELD OF THE INVENTION

The present invention relates generally to systems and methods for manipulating foreign and domestic patent systems and, more particularly, to a business system and methodology for legally extending a patent monopoly on one or more selected inventions through a series of patents directed to such inventions.

### BACKGROUND OF THE INVENTION

Product development frequently involves a considerable monetary investment. In the case of a pharmaceutical composition, the investments in cash and capital required are typically enormous.

Current practices for attempting to delay and prevent entry of competitive pharmaceutical compositions in the marketplace can enable the corporate developer to sell its composition at a relatively high price. The high corporate earnings achieved through prolonging the monopoly are considered beneficial for purposes of demonstrating high earnings and increased profitability. This, in turn, enables the developer to pay considerable dividends to its shareholders, and results increased value to others having financial interests in the developer.

While a patent may grant a legal monopoly on a fundamental active ingredient of a pharmaceutical composition, such monopoly is limited in duration and does not insure that the developer will receive a steady, prolonged revenue stream.

### OBJECTS AND SUMMARY OF THE INVENTION

One objective of embodiments of the present invention is to provide a system and method for delaying the introduction of a competitor's product to the market by extending the duration of protection afforded by one or more patents.

Another object of the invention is to demonstrate that flaws inherent in the patent system that allow developers of pharmaceutical compositions to engage in commercial practices that enable them to extend the monopolies of patents by apparently lawful means that are nevertheless in contravention of both national patent laws and binding international treaties.

A further object of the invention is to use the relatively high earnings achieved through prolonging a patent monopoly on a pharmaceutical composition to demonstrate high earnings and increased profitability.

It is still another object of the invention to facilitate payment of dividends to common stock holders of the developer.

In accordance with a preferred embodiment of the present invention, a method for extending the period of traditional patent protection is presented, the method comprising the steps of:
(i) Developing an active ingredient for a chemical composition;
(ii) Filing an initial patent application in a selected country on behalf of a developer of the active ingredient, said application being directed to said active ingredient for the chemical composition;
(iii) Obtaining an initial certificate of patent granted for said active ingredient;
(iv) Releasing limited data relating to the active ingredient;
(v) Ensuring that said limited data comprises all data on the active ingredient available to public;
(vi) Identifying at least a first time interval during product life of the active ingredient which commences upon submission of said initial application directed to protection of the active ingredient and ends on the date that authorization is obtained from one of a group of government related regulatory authorities for marketing at least one element of the list comprising: said active ingredient, a composition including said active ingredient, a characteristic of the active ingredient and a characteristic of the composition including the active ingredient

Wherein the element is characterized by being generally unknown by any entity other than the developer or those legally bound to the developer by a conventional non-disclosure agreement;
(vii) Identifying at least a second time interval during the product life of the element ending upon expiration of the certificate of the initial patent grant; said second interval being characterized by a lack of initiative by a third party developer to independently produce and market the active ingredient or a composition including the active ingredient in competition with the developer;
(viii) Filing a subsequent patent application on behalf of the developer in the same country as the initial application, the subsequent application being based upon the initial application, having subject matter in common with the initial application, and having continuity of filing with respect to the initial application, wherein the second application is directed to newly appreciated properties or characteristics of the active ingredient or of a composition comprising the active ingredient; and (ix) Obtaining a subsequent certificate of patent grant on the subsequent application, thereby, lawfully interfering with the production and marketing of such active ingredient and/or the composition including the active ingredient by the one or more third party developers, which would otherwise occur upon expiration of the initial certificate of patent grant and the lawful patent monopoly granted thereby.

According to another aspect of the present invention, a method is provided for extending the period of traditional patent protection, comprising the steps of: Developing a chemical composition having an active ingredient; Filing an initial patent application in a selected country on behalf of the developer of the composition, such application being directed to the composition having the active ingredient; Obtaining an initial certificate of patent grant on the composition having the active ingredient; Releasing limited data from the developer relating to the composition having the active ingredient, such data being the only publicly available data on the composition including the active ingredient; Identifying at least a first time interval during product life of the composition having the active ingredient which commences upon submission of the initial application directed to protection of the composition having the active ingredient and ends on the date that authorization is obtained from one of a group of government related regulatory authorities for marketing the composition having the active ingredient, any characteristic(s) of the composition including the active ingredient being generally unknown by any person and/or entity other than the developer and those that may be legally bound by a conventional non-disclosure agreement; Identifying at least a second time interval during the product life of the composition having the active ingredient, the second interval beginning on the date that initial marketing of the composition having the active ingredient commenced and ending upon expiration of the certificate of the initial patent grant, there being no initiative during the second interval, in view of the patent monopoly, for one or more third party developers to independently produce and market the composition having the active ingredient in competition with the developer; Filing a subsequent patent application on behalf of the developer in the same country as the initial application before the end of either of the first and second time intervals during which only the limited data regarding the composition having the active ingredient is publicly available; the subsequent application being based upon the initial application and being characterized by having subject matter in common with the initial application, and having continuity of filing with respect to the initial application, the second application being directed to newly appreciated properties or characteristics of the composition including the active ingredient; obtaining a subsequent certificate of patent grant on the subsequent application, thereby lawfully interfering with production and marketing of the active ingredient or a composition including the active ingredient by the one or more third party developers, which would otherwise occur upon expiration of the initial certificate of patent grant and the lawful patent monopoly granted thereby.

In accordance with a further aspect of the invention is a method for extending the period of traditional patent protection, comprising the steps of: Developing an active ingredient for a chemical composition; Filing an initial patent application in a selected country on behalf of the developer of the active ingredient, such application being directed to the active ingredient for the chemical composition; Obtaining an initial certificate of patent grant on the active ingredient; Releasing limited data from the developer relating to the active ingredient and/or the composition having the active ingredient, such data being the only publicly available data on the active ingredient and/or the composition having the active ingredient; Identifying at least a first time interval during the product life of the active ingredient and/or the composition including the active ingredient which commences upon submission of the initial application directed to protection of the active ingredient and ends on the date that authorization is obtained from one of a group of government related regulatory authorities for marketing the active ingredient and/or the composition having the active ingredient, any characteristic(s) of the active ingredient and/or the composition having the active ingredient being generally unknown by any person and/or entity other than the developer and those that may be legally bound by a conventional non-disclosure agreement; identifying at least a second time interval during the product life of the active ingredient and/or the composition having the active ingredient, the second interval beginning on the date that initial marketing of the active ingredient and/or the composition having the active ingredient commenced and ending upon expiration of the certificate of patent grant, there being no initiative during the second interval, in view of the patent monopoly, for one or more third party developers to independently produce and market the active ingredient and/or the composition having the active ingredient in competition with the developer; before the end of either of the first and second time intervals during which only the limited data regarding the active ingredient and/or the composition having the active ingredient is publicly available, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the active ingredient and/or the composition having the active ingredient, such new subject matter constituting one or more modifications relating to the active ingredient and/or the composition having the active ingredient; and obtaining a subsequent certificate of patent grant on the subsequent application, thereby lawfully interfering with the production and marketing of such active ingredient and/or the composition having the active ingredient by the one or more third party developers, which would otherwise occur upon expiration of the certificate of patent grant and the lawful patent monopoly granted thereby.

According to still another aspect of the invention is a method for extending the period of traditional patent protection, comprising the steps of: Developing a chemical composition having an active ingredient; Filing an initial patent application in a selected country on behalf of the developer of the composition, such application being directed to the chemical composition having the active ingredient; Obtaining an initial certificate of patent grant on the composition; Releasing limited data from the developer relating to the active ingredient and/or the composition having the active ingredient, such data being the only publicly available data on the active ingredient and/or the composition having the active ingredient; Identifying at least a first time interval during the product life of the composition having the active ingredient which commences upon submission of the initial application directed to protection of the composition and ends on the date that authorization is obtained from one of a group of government related regulatory authorities for marketing the composition having the active ingredient, any characteristic(s) of the composition having the active ingredient being generally unknown by any person and/or entity other than the developer and those that may be legally bound by a conventional non-disclosure agreement; identifying at least a second time interval during the product life of the composition having the active ingredient, the second interval beginning on the date that initial marketing of the composition having the active ingredient commenced and ending upon expiration of the certificate of patent grant, there being no initiative during the second interval, in view of the patent monopoly, for one or more third party developers to independently produce and market the composition having the active ingredient in competition with the developer; before the end of either of the first and second time intervals during which only the limited data regarding the composition having the active ingredient is publicly available, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the composition having the active ingredient, such new subject matter constituting one or more modifications relating to the composition having the active ingredient and obtaining a subsequent certificate of patent grant on the subsequent application, thereby, lawfully interfering with the production and marketing of such composition having the active ingredient by the one or more third party developers, which would otherwise occur upon expiration of the certificate of patent grant and the lawful patent monopoly granted thereby.

Yet another aspect of the invention is directed to providing a method for extending the period of traditional patent protection, comprising the steps of: developing an active ingredient for a chemical composition; filing an initial patent application in a selected country on behalf of the developer of the active ingredient, such application being directed to the active ingredient for the chemical composition; obtaining an initial certificate of patent grant on the active ingredient; releasing limited data from the developer relating to the active ingredient and/or the composition having the active ingredient, such data being the only publicly available data on the active ingredient and/or the composition having the active ingredient; identifying at least a first time interval during the product life of the active ingredient and/or the composition having the active ingredient which commences upon submission of the initial application directed to protection of the active ingredient and ends on the date that authorization is obtained from one of a group of government related regulatory authorities for marketing the active ingredient and/or the composition having the active ingredient, any characteristic(s) of the active ingredient and/or the composition having the active ingredient being generally unknown by any person and/or entity other than the developer and those that may be legally bound by a conventional non-disclosure agreement; identifying at least a second time interval during the product life of the active ingredient and/or the composition having the active ingredient, the second interval beginning on the date that initial marketing of the active ingredient and/or the composition having the active ingredient commenced and ending upon expiration of the certificate of patent grant, there being no initiative during the second interval, in view of the patent monopoly, for one or more third party developers to independently produce and market the active ingredient and/or the composition having the active ingredient in competition with the developer; before the end of either of the first and second time intervals during which only the limited data regarding the active ingredient and/or the composition having the active ingredient is publicly available, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the active ingredient, such new subject matter constituting one or more new applications of the active ingredient; and obtaining a subsequent certificate of patent grant on the subsequent application, thereby, lawfully interfering with the production and marketing of such active ingredient by the one or more third party developers, which would otherwise occur upon expiration of the certificate of patent grant and the lawful patent monopoly granted thereby.

A further aspect of the invention concerns a method for extending the period of traditional patent protection, comprising the steps of: developing a chemical composition having an active ingredient; filing an initial patent application in a selected country on behalf of the developer of the composition, such application being directed to the chemical composition having the active ingredient; obtaining an initial certificate of patent grant on the composition; releasing limited data from the developer relating to the composition having the active ingredient, such data being the only publicly available data on the composition having the active ingredient; identifying at least a first time interval during the product life of the composition having the active ingredient which commences upon submission of the initial application directed to protection of the composition and ends on the date that authorization is obtained from one of a group of government related regulatory authorities for marketing the composition, any characteristic(s) of the composition having the active ingredient being generally unknown by any person and/or entity other than the developer and those that may be legally bound by a conventional non-disclosure agreement; identifying at least a second time interval during the product life of the composition having the active ingredient, the second interval beginning on the date that initial marketing of the composition having the active ingredient commenced and ending upon expiration of the certificate of patent grant, there being no initiative during the second interval, in view of the patent monopoly, for one or more third party developers to independently produce and market the composition having the active ingredient in competition with the developer; before the end of either of the first and second time intervals during which only the limited data regarding the composition having the active ingredient is publicly available, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the composition, such new subject matter constituting one or more new applications of the composition having the active ingredient; and obtaining a subsequent certificate of patent grant on the subsequent application, thereby, lawfully interfering with the production and marketing of such composition having the active ingredient by the one or more third party developers, which would otherwise occur upon expiration of the certificate of patent grant and the lawful patent monopoly granted thereby.

Still another aspect of the invention is a method for extending the period of traditional patent protection, comprising the steps of: developing an active ingredient for a chemical corn position; filing an initial patent application in a selected country on behalf of the developer of the active ingredient, such application being directed to the active ingredient for the chemical composition; obtaining an initial certificate of patent grant on the active ingredient; releasing limited data from the developer regarding the active ingredient and/or the composition having the active ingredient, such data being the only publicly available data on the active ingredient and/or the composition having the active ingredient; identifying at least a first time interval during the product life of the active ingredient and/or the composition having the active ingredient which commences upon submission of the initial application directed to protection of the active ingredient and ends on the date that authorization is obtained from one of a group of government related regulatory authorities for marketing the active ingredient and/or the composition having the active ingredient, any characteristic(s) of the active ingredient and/or the composition having the active ingredient being generally unknown by any person and/or entity other than the developer and those that may be legally bound by a conventional non-disclosure agreement; identifying at least a second time interval during the product life of the active ingredient and/or the composition having the active ingredient, the second interval beginning on the date that initial marketing of the active ingredient commenced and ending upon expiration of the certificate of patent grant, there being no initiative during the second interval, in view of the patent monopoly, for one or more third party developers to independently produce and market the active ingredient and/or the composition having the active ingredient in competition with the developer; before the end of either of the first and second time intervals during which only the limited data regarding the active ingredient and/or the composition having the active ingredient is publicly available, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the active ingredient, such new subject matter constituting one or more methods of treatment using the active ingredient; and obtaining a subsequent certificate of patent grant on the subsequent application, thereby lawfully interfering with the production and marketing of such active ingredient by the one or more third party developers, which would otherwise occur upon expiration of the certificate of patent grant and the lawful patent monopoly granted thereby.

Still a further aspect of the invention is a method for extending the period of traditional patent protection, comprising the steps of:

developing a chemical composition having an active ingredient;

filing an initial patent application in a selected country on behalf of the developer of the composition, such application being directed to the chemical composition having the active ingredient;

obtaining an initial certificate of patent grant on the composition;

releasing limited data from the developer regarding the composition, such data being the only publicly available data on the composition having the active ingredient;

identifying at least a first time interval during the product life of the composition which commences upon submission of the initial application directed to protection of the composition and ends on the date that authorization is obtained from one of a group of government related regulatory authorities for marketing the composition, any characteristic(s) of the composition having the active ingredient being generally unknown by any person and/or entity other than the developer and those that may be legally bound by a conventional non-disclosure agreement;

identifying at least a second time interval during the product life of the composition having the active ingredient, the second interval beginning on the date that initial marketing of the composition commenced and ending upon expiration of the certificate of patent grant, there being no initiative during the second interval, in view of the patent monopoly, for one or more third party developers to independently produce and market the composition having the active ingredient in competition with the developer; before the end of either of the first and second time intervals during which only the limited data regarding the composition having the active ingredient is publicly available, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the composition, such new subject matter constituting one or more methods of treatment using the composition having the active ingredient; and obtaining a subsequent certificate of patent grant on the subsequent application, thereby, lawfully interfering with the production and marketing of such active ingredient by the one or more third party developers, which would otherwise occur upon expiration of the certificate of patent grant and the lawful patent monopoly granted thereby.

Yet a further aspect of the invention concerns a method for extending the period of traditional patent protection, comprising the steps of:

developing an active ingredient for a chemical composition;

filing an initial patent application in a selected country on behalf of the developer of the active ingredient, such application being directed to the active ingredient for the chemical composition;

obtaining an initial certificate of patent grant on the active ingredient;

releasing limited data from the developer relating to the active ingredient and/or the composition having the active ingredient, such data being the only publicly available data on the active ingredient and/or the composition having the active ingredient;

identifying at least a first time interval during the product life of the active ingredient and/or the composition having the active ingredient which commences upon submission of the initial application directed to protection of the active ingredient and ends on the date that authorization is obtained from one of a group of government related regulatory authorities for marketing the active ingredient, any characteristic(s) of the active ingredient and/or the composition having the active ingredient being generally unknown by any person and/or entity other than the developer and those that may be legally bound by a conventional non-disclosure agreement;

identifying at least a second time interval during the product life of the active ingredient and/or the composition having the active ingredient, the second interval beginning on the date that initial marketing of the active ingredient and/or the composition having the active ingredient commenced and ending upon expiration of the certificate of patent grant, there being no initiative during the second interval, in view of the patent monopoly, for one or more third party developers to independently produce and market the active ingredient and/or the composition having the active ingredient in competition with the developer;

before the end of either of the first and second time intervals during which only the limited data regarding the active ingredient and/or the composition having the active ingredient is publicly available, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the active ingredient, such new subject matter constituting one or more commercially desirable chemical additives to the active ingredient or one or more chemical additives absent from the active ingredient; and

obtaining a subsequent certificate of patent grant on the subsequent application, thereby, lawfully interfering with the production and marketing of such the active ingredient and/or the composition having the active ingredient by the one or more third party developers, which would otherwise occur upon expiration of the certificate of patent grant and the lawful patent monopoly granted thereby.

Another aspect of the invention concerns a method for extending the period of traditional patent protection, comprising the steps of:

developing a chemical composition having an active ingredient;

filing an initial patent application in a selected country on behalf of the developer of the composition, such application being directed to the chemical composition having the active ingredient;

obtaining an initial certificate of patent grant on the composition;

releasing limited data from the developer relating to the composition, such data being the only publicly available data on the composition having the active ingredient;

identifying at least a first time interval during the product life of the composition having the active ingredient which commences upon submission of the initial application directed to protection of the composition and ends on the date that authorization is obtained from one of a group of government related regulatory authorities for marketing the composition, any characteristic(s) of the composition having the active ingredient being generally unknown by any person and/or entity other than the developer and those that may be legally bound by a conventional non-disclosure agreement;
identifying at least a second time interval during the product life of the composition having the active ingredient, the second interval beginning on the date that initial marketing of composition commenced and ending upon expiration of the certificate of patent grant, there being no initiative during the second interval, in view of the patent monopoly, for one or more third party developers to independently produce and market the composition having the active ingredient in competition with the developer;

before the end of either of the first and second time intervals during which only the limited data regarding the composition having the active ingredient is publicly available, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the composition, such new subject matter constituting one or more commercially desirable chemical additives to the composition having the active ingredient or one or more chemical additives necessarily absent from the composition having the active ingredient; and

obtaining a subsequent certificate of patent grant on the subsequent application, thereby, lawfully interfering with the production and marketing of such the composition having the active ingredient by the one or more third party developers, which would otherwise occur upon expiration of the certificate of patent grant and the lawful patent monopoly granted thereby.

Yet another aspect of the present invention is directed to a method for extending the period of traditional patent protection, comprising the steps of:

developing an active ingredient for a chemical composition;

filing an initial patent application in a selected country on behalf of the developer of the active ingredient, such application being directed to the active ingredient for the chemical composition;

obtaining an initial certificate of patent grant on the active ingredient;

identifying at least a first time interval during the product life of the active ingredient and/or the composition having the active ingredient which commences upon submission of the initial application directed to protection of the active ingredient and ends on the date that authorization is obtained from one of a group of government related regulatory authorities for marketing the active ingredient and/or the composition having the active ingredient, any characteristic(s) of the active ingredient and/or the composition having the active ingredient being generally unknown by any person and/or entity other than the developer and those that may be legally bound by a conventional non-disclosure agreement;

identifying at least a second time interval during the product life of the active ingredient and/or the composition having the active ingredient, the second interval beginning on the date that initial marketing of the active ingredient and/or the composition having the active ingredient commenced and ending upon expiration of the certificate of patent grant, there being no initiative during the second interval, in view of the patent monopoly, for one or more third party developers to independently produce and market the active ingredient and/or the composition having the active ingredient in competition with the developer;

before the end of either of the first and second time intervals during which only the chemical name of the active ingredient and/or the composition having the active ingredient is made publicly available by the developer, filing a subsequent patent application on behalf of the developer in the same country as the initial application, the subsequent application being based upon the initial application, having subject matter in common with the initial application, and having continuity of filing with respect to the initial application, such application being directed to newly appreciated properties or characteristics of the active ingredient; and

obtaining a subsequent certificate of patent grant on the subsequent application, thereby, lawfully interfering with the production and marketing of such active ingredient and/or composition having the active ingredient by the one or more third party developers, which would otherwise occur upon expiration of the certificate of patent grant and the lawful patent monopoly granted thereby.

Still another aspect of the present invention is directed to a method for extending the period of traditional patent protection, comprising the steps of: developing a chemical composition having an active ingredient; filing an initial patent application in a selected country on behalf of the developer of the composition, such application being directed to the chemical composition having the active ingredient; obtaining an initial certificate of patent grant on the composition; identifying at least a first time interval during the product life of the composition having the active ingredient which commences upon submission of the initial application directed to protection of the composition and ends on the date that authorization is obtained from one of a group of government related regulatory authorities for marketing the composition, any characteristic(s) of the composition having the active ingredient being generally unknown by any person and/or entity other than the developer and those that may be legally bound by a conventional non-disclosure agreement; identifying at least a second time interval during the product life of the composition having the active ingredient, the second interval beginning on the date that initial marketing of the composition commenced and ending upon expiration of the certificate of patent grant, there being no initiative during the second interval, in view of the patent monopoly, for one or more third party developers to independently produce and market the composition having the active ingredient in competition with the developer; before the end of either of the first and second time intervals during which only the chemical name of the composition having the active ingredient is made publicly available by the developer, filing a subsequent patent application on behalf of the developer in the same country as the initial application, the subsequent application being based upon the initial application, having subject matter in common with the initial application, and having continuity of filing with respect to the initial application, such application being directed to newly appreciated properties or characteristics of the composition having the active ingredient; and obtaining a subsequent certificate of patent grant on the subsequent application, thereby, lawfully interfering with the production and marketing of such composition having the active ingredient by the one or more third party developers, which would otherwise occur upon expiration of the certificate of patent grant and the lawful patent monopoly granted thereby.

In accordance with a further aspect of the invention is a method for extending the period of traditional patent protection, comprising the steps of: developing an active ingredient for a chemical composition; filing an initial patent application in a selected country on behalf of the developer of the active ingredient, such application being directed to the active ingredient for the chemical composition; obtaining an initial certificate of patent grant on the composition including the active ingredient; identifying at least a first time interval during the product life of the active ingredient and/or the composition having the active ingredient which commences upon submission of the initial application directed to protection of the active ingredient and ends on the date that authorization is obtained from one of a group of government related regulatory authorities for marketing the active ingredient and/or the composition having the active ingredient, any characteristic(s) of the active ingredient and/or the composition having the active ingredient being generally unknown by any person and/or entity other than the developer and those that may be legally bound by a conventional non-disclosure agreement; identifying at least a second time interval during the product life of the active ingredient and/or the composition having the active ingredient, the second interval beginning on the date that initial marketing of the active ingredient and/or the composition having the active ingredient commenced and ending upon expiration of the certificate of patent grant, there being no initiative during the second interval, in view of the patent monopoly, for one or more third party developers to independently produce and market the active ingredient and/or the composition having the active ingredient in competition with the developer; before the end of either of the first and second time intervals during which only the chemical name of the active ingredient and/or the composition having the active ingredient is made publicly available by the developer, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the active ingredient, such new subject matter constituting one or more modifications relating to the active ingredient; and obtaining a subsequent certificate of patent grant on the subsequent application, thereby, lawfully interfering with the production and marketing of such active ingredient and/or composition having the active ingredient by the one or more third party developers, which would otherwise occur upon expiration of the certificate of patent grant and the lawful patent monopoly granted thereby.

According to still another aspect of the invention is a method for extending the period of traditional patent protection, comprising the steps of: developing a chemical composition having an active ingredient; filing an initial patent application in a selected country on behalf of the developer of the composition, such application being directed to the chemical composition having the active ingredient; obtaining an initial certificate of patent grant on the composition having the active ingredient; identifying at least a first time interval during the product life of the composition having the active ingredient which commences upon submission of the initial application directed to protection of the composition and ends on the date that authorization is obtained from one of a group of government related regulatory authorities for marketing the composition having the active ingredient, any characteristic(s) of the composition being generally unknown by any person and/or entity other than the developer and those that may be legally bound by a conventional non-disclosure agreement; identifying at least a second time interval during the product life of the composition having the active ingredient, the second interval beginning on the date that initial marketing of the composition commenced and ending upon expiration of the certificate of patent grant, there being no initiative during the second interval, in view of the patent monopoly, for one or more third party developers to independently produce and market the composition having the active ingredient in competition with the developer; before the end of either of the first and second time intervals during which only the chemical name of the composition is made publicly available by the developer, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the composition, such new subject matter constituting one or more modifications relating to the composition having the active ingredient; and obtaining a subsequent certificate of patent grant on the subsequent application, thereby, lawfully interfering with the production and marketing of such composition having the active ingredient by the one or more third party developers, which would otherwise occur upon expiration of the certificate of patent grant and the lawful patent monopoly granted thereby.

In accordance with yet a further aspect of the invention is a method for extending the period of traditional patent protection, comprising the steps of:

developing an active ingredient for a chemical composition;

filing an initial patent application in a selected country on behalf of the developer of the active ingredient, such application being directed to the active ingredient for the chemical composition;

obtaining an initial certificate of patent grant on the active ingredient;

releasing limited data from the developer relating to the active ingredient and/or the chemical composition having the active ingredient, such data being the only publicly available data on the active ingredient and/or the chemical composition having the active ingredient;

identifying at least a first time interval during the product life of the active ingredient and/or the chemical composition having the active ingredient which commences upon submission of the initial application directed to protection of the active ingredient and ends on the date that authorization is obtained from one of a group of government related regulatory authorities for marketing the active ingredient and/or the chemical composition having the active ingredient, any characteristic(s) of the active ingredient and/or the chemical composition having the active ingredient being generally unknown by any person and/or entity other than the developer and those that may be legally bound by a conventional non-disclosure agreement;

identifying at least a second time interval during the product life of the active ingredient and/or the chemical composition having the active ingredient, the second interval beginning on the date that initial marketing of the active ingredient and/or the chemical composition having the active ingredient commenced and ending upon expiration of the certificate of patent grant, there being no initiative during the second interval, in view of the patent monopoly, for one or more third party developers to independently produce and market the active ingredient and/or the chemical composition having the active ingredient in competition with the developer;

before the end of either of the first and second time intervals during which only the limited data regarding the active ingredient and/or the chemical composition having the active ingredient is publicly available, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the active ingredient, such new subject matter constituting one or more new applications of the active ingredient; and

obtaining a subsequent certificate of patent grant on the subsequent application, thereby, lawfully interfering with the production and marketing of such active ingredient and/or chemical composition having the active ingredient by the one or more third party developers, which would otherwise occur upon expiration of the certificate of patent grant and the lawful patent monopoly granted thereby.

According to yet another aspect of the invention is a method for extending the period of traditional patent protection, comprising the steps of:

developing a chemical composition having an active ingredient;

filing an initial patent application in a selected country on behalf of the developer of the composition, such application being directed to the chemical composition having the active ingredient;

obtaining an initial certificate of patent grant on the composition;

releasing limited data from the developer relating to the composition having the active ingredient, such data being the only publicly available data on the composition having the active ingredient;

identifying at least a first time interval during the product life of the chemical composition having the active ingredient which commences upon submission of the initial application directed to protection of the composition and ends on the date that authorization is obtained from one of a group of government related regulatory authorities for marketing the chemical composition having the active ingredient, any characteristic(s) of the chemical composition having the active ingredient being generally unknown by any person and/or entity other than the developer and those that may be legally bound by a conventional non-disclosure agreement;

identifying at least a second time interval during the product life of the chemical composition having the active ingredient, the second interval beginning on the date that initial marketing of the composition having the active ingredient commenced and ending upon expiration of the certificate of patent grant, there being no initiative during the second interval, in view of the patent monopoly, for one or more third party developers to independently produce and market the chemical composition having the active ingredient in competition with the developer;

before the end of either of the first and second time intervals during which only the limited data regarding the chemical composition having the active ingredient is publicly available, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the composition, such new subject matter constituting one or more new applications of the composition having the active ingredient; and

obtaining a subsequent certificate of patent grant on the subsequent application, thereby, lawfully interfering with the production and marketing of such chemical composition having the active ingredient by the one or more third party developers, which would otherwise occur upon expiration of the certificate of patent grant and the lawful patent monopoly granted thereby.

In accordance with another aspect of the invention is a method for extending the period of traditional patent protection, comprising the steps of:

developing an active ingredient for a chemical composition;

filing an initial patent application in a selected country on behalf of the developer of the active ingredient, such application being directed to the active ingredient for the chemical composition;

obtaining an initial certificate of patent grant on the active ingredient;

identifying at least a first time interval during the product life of the active ingredient and/or the chemical composition having the active ingredient which commences upon submission of the initial application directed to protection of the active ingredient and ends on the date that authorization is obtained from one of a group of government related regulatory authorities for marketing the active ingredient and/or the chemical composition having the active ingredient, any characteristic(s) of the active ingredient and/or the chemical composition having the active ingredient being generally unknown by any person and/or entity other than the developer and those that may be legally bound by a conventional non-disclosure agreement;

identifying at least a second time interval during the product life of the active ingredient and/or the chemical composition having the active ingredient, the second interval beginning on the date that initial marketing of the active ingredient and/or the chemical composition having the active ingredient commenced and ending upon expiration of the certificate of patent grant, there being no initiative during the second interval, in view of the patent monopoly, for one or more third party developers to independently produce and market the active ingredient and/or the chemical composition having the active ingredient in competition with the developer;

before the end of either of the first and second time intervals during which only the chemical name of the active ingredient and/or the composition having the active ingredient is made publicly available by the developer, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the active ingredient, such new subject matter constituting one or more methods of treatment using the active ingredient; and

obtaining a subsequent certificate of patent grant on the subsequent application, thereby, lawfully interfering with the production and marketing of such active ingredient and/or chemical composition having the active ingredient by the one or more third party developers, which would otherwise occur upon expiration of the certificate of patent grant and the lawful patent monopoly granted thereby.

A further aspect of the invention is directed to a method for extending the period of traditional patent protection, comprising the steps of:

developing a chemical composition having an active ingredient;

filing an initial patent application in a selected country on behalf of the developer of the chemical composition, such application being directed to the chemical composition having the active ingredient;

obtaining an initial certificate of patent grant on the composition having the active ingredient;

identifying at least a first time interval during the product life of chemical composition having the active ingredient which commences upon submission of the initial application directed to protection of the composition and ends on the date that authorization is obtained from one of a group of government related regulatory authorities for marketing the chemical composition having the active ingredient, any characteristic(s) of the chemical composition having the active ingredient being generally unknown by any person and/or entity other than the developer and those that may be legally bound by a conventional non-disclosure agreement;

identifying at least a second time interval during the product life of the chemical composition having the active ingredient, the second interval beginning on the date that initial marketing of the chemical composition having the active ingredient commenced and ending upon expiration of the certificate of patent grant, there being no initiative during the second interval, in view of the patent monopoly, for one or more third party developers to independently produce and market the active ingredient and/or the chemical composition having the active ingredient in competition with the developer;

before the end of either of the first and second time intervals during which only the chemical name of the composition having the active ingredient is made publicly available by the developer, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the composition having the active ingredient, such new subject matter constituting one or more methods of treatment using the composition having the active ingredient; and

obtaining a subsequent certificate of patent grant on the subsequent application, thereby, lawfully interfering with the production and marketing of such chemical composition having the active ingredient by the one or more third party developers, which would otherwise occur upon expiration of the certificate of patent grant and the lawful patent monopoly granted thereby.

Still a further aspect of the invention is directed to a method for extending the period of traditional patent protection, comprising the steps of:

developing an active ingredient for a chemical composition;

filing an initial patent application in a selected country on behalf of the developer of the active ingredient, such application being directed to the active ingredient for the chemical composition;

obtaining an initial certificate of patent grant on the active ingredient;

identifying at least a first time interval during the product life of the active ingredient and/or the composition having the active ingredient which commences upon submission of the initial application directed to protection of the active ingredient and ends on the date that authorization is obtained from one of a group of government related regulatory authorities for marketing the active ingredient and/or the composition having the active ingredient, any characteristic(s) of the active ingredient and/or the composition having the active ingredient being generally unknown by any person and/or entity other than the developer and those that may be legally bound by a conventional non-disclosure agreement;

identifying at least a second time interval during the product life of the active ingredient and/or the composition having the active ingredient, the second interval beginning on the date that initial marketing of the active ingredient and/or the composition having the active ingredient commenced and ending upon expiration of the certificate of patent grant there being no initiative during the second interval, in view of the patent monopoly, for one or more third party developers to independently produce and market the active ingredient and/or the composition having the active ingredient in competition with the developer;

before the end of either of the first and second time intervals during which only the chemical name of the active ingredient and/or the composition having the active ingredient is made publicly available by the developer, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the active ingredient, such new subject matter constituting one or more commercially desirable chemical additives to the active ingredient for the chemical composition; and

obtaining a subsequent certificate of patent grant on the subsequent application, thereby, lawfully interfering with the production and marketing of such active ingredient and/or composition having the active ingredient by the one or more third party developers, which would otherwise occur upon expiration of the certificate of patent grant and the lawful patent monopoly granted thereby.

Yet a another aspect of the invention is directed to a method for extending the period of traditional patent protection, comprising the steps of:

developing a chemical composition having an active ingredient;

filing an initial patent application in a selected country on behalf of the developer of the composition, such application being directed to the chemical composition having the active ingredient;

obtaining an initial certificate of patent grant on the composition having the active ingredient;

identifying at least a first time interval during the product life of the composition having the active ingredient which commences upon submission of the initial application directed to protection of the composition and ends on the date that authorization is obtained from one of a group of government related regulatory authorities for marketing the composition having the active ingredient, any characteristic(s) of the composition having the active ingredient being generally unknown by any person and/or entity other than the developer and those that may be legally bound by a conventional non-disclosure agreement;

identifying at least a second time interval during the product life of the composition having the active ingredient, the second interval beginning on the date that initial marketing of the composition having the active ingredient commenced and ending upon expiration of the certificate of patent grant, there being no initiative during the second interval, in view of the patent monopoly, for one or more third party developers to independently produce and market the composition having the active ingredient in competition with the developer;

before the end of either of the first and second time intervals during which only the chemical name of the composition having the active ingredient is made publicly available by the developer, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the composition, such new subject matter constituting one or more commercially desirable chemical additives to the chemical composition having the active ingredient; and

obtaining a subsequent certificate of patent grant on the subsequent application, thereby, lawfully interfering with the production and marketing of such composition having the active ingredient by the one or more third party developers, which would otherwise occur upon expiration of the certificate of patent grant and the lawful patent monopoly granted thereby.

Another aspect of the invention is directed to a method for extending the period of traditional patent protection, comprising the steps of:

developing an active ingredient for a chemical composition, such active ingredient including at least one polymorph or pseudo-polymorph;

filing an initial patent application in a selected country on behalf of the developer of the active ingredient, such application being directed to the active ingredient for the chemical composition, which ingredient includes the polymorph or pseudo-polymorph, and for which no known method is disclosed for manufacturing the same;

obtaining an initial certificate of patent grant on the active ingredient which includes the polymorph or pseudo-polymorph;

identifying at least a first time interval during the product life of the active ingredient and/or the composition having the active ingredient which commences upon submission of the initial application directed to protection of the active ingredient and ends on the date that authorization is obtained from one of a group of government related regulatory authorities for marketing the active ingredient and/or the composition having the active ingredient, any characteristic(s) of the active ingredient including the polymorph or pseudo-polymorph and/or the chemical composition having such active ingredient being generally unknown by any person and/or entity other than the developer and those that may be legally bound by a conventional non-disclosure agreement;

identifying at least a second time interval during the product life of the active ingredient and/or the composition having the active ingredient, the second interval beginning on the date that initial marketing of the active ingredient and/or the composition having the active ingredient commenced and ending upon expiration of the certificate of patent grant, there being no initiative during the second interval, in view of the patent monopoly, for one or more third party developers to independently produce and market the active ingredient and/or the composition having the active ingredient in competition with the developer;

before the end of either of the first and second time intervals during which only the chemical name of the active ingredient and/or the composition having the active ingredient is made publicly available by the developer, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the composition having the active ingredient, such new subject matter constituting a method of manufacturing the active ingredient with the polymorph or pseudo-polymorph; and

obtaining a subsequent certificate of patent grant on the subsequent application, thereby, lawfully interfering with the production and marketing of such active ingredient and/or composition having such active ingredient with the polymorph or pseudo-polymorph by the one or more third party developers, which would otherwise occur upon expiration of the certificate of patent grant and the lawful patent monopoly granted thereby.

According to another aspect of the invention is directed to a method for extending the period of traditional patent protection, comprising the steps of:

developing a chemical composition having an active ingredient including at least one polymorph or pseudo-polymorph;

filing an initial patent application in a selected country on behalf of the developer of the active ingredient, such application being directed to the active ingredient which includes the polymorph or pseudo-polymorph, and for which no known method is disclosed for manufacturing the same;

obtaining an initial certificate of patent grant on the active ingredient which includes the polymorph or pseudo-polymorph;

identifying at least a first time interval during the product life of the composition which commences upon submission of the initial application directed to protection of the active ingredient and/or the composition having the active ingredient and ends on the date that authorization is obtained from one of a group of government related regulatory authorities for marketing the composition with the active ingredient, any characteristic(s) of the composition having the active ingredient including the polymorph or pseudo-polymorph being generally unknown by any person and/or entity other than the developer and those that may be legally bound by a conventional non-disclosure agreement;

identifying at least a second time interval during the product life of the composition, the second interval beginning on the date that initial marketing of the composition commenced and ending upon expiration of the certificate of patent grant, there being no initiative during the second interval, in view of the patent monopoly, for one or more third party developers to independently produce and market the composition in competition with the developer;

before the end of either of the first and second time intervals during which only the chemical name of the composition having the active ingredient is made publicly available by the developer, filing a subsequent patent application on behalf of the developer in the same country as the initial application, the subsequent application being based upon the initial application, having subject matter in common with the initial application, and having continuity of filing with respect to common subject matter in the initial application, but containing new subject matter relating to the composition having the active ingredient, such new subject matter constituting a method of manufacturing the composition including the active ingredient with the polymorph or pseudo-polymorph; and

obtaining a subsequent certificate of patent grant on the subsequent application, thereby, lawfully interfering with the production and marketing of such composition including the active ingredient with the polymorph or pseudo-polymorph by the one or more third party developers, which would otherwise occur upon expiration of the certificate of patent grant and the lawful patent monopoly granted thereby.

Another object of the invention is to provide a system for lawfully increasing the period of a patent monopoly of a pharmaceutical composition, that comprises:

a programmable apparatus including a central processing unit for implementing the method and read only memory for housing programming for word processing and preparation of a patent application, filing the patent application virtually in the a foreign or domestic Patent Office and for extending the period of patent protection obtained, a display monitor for visual illustration of the method, an Internet compatible communications modem 13, and a data input device;

a server for sending and receiving data packets to the programmable apparatus; and

a communications network for linking the apparatus to the server.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

The same numerals are used throughout the figure drawings, set forth below, to designate similar elements.

FIG. 1 is a schematic diagram illustrating a system for extending the period of traditional patent protection, according to one aspect of the present invention;

FIG. 2 is a flow diagram illustrating a method for extending the period of traditional patent protection relating to development of an active ingredient for a chemical composition, in accordance with one aspect of the present invention; and

FIG. 3 is a flow diagram illustrating a method for extending the period of traditional patent protection directed to development of a chemical composition having an active ingredient, in accordance with one aspect of the present invention.

### DETAILED DESCRIPTION OF THE PREFERRED EMBODIMENTS

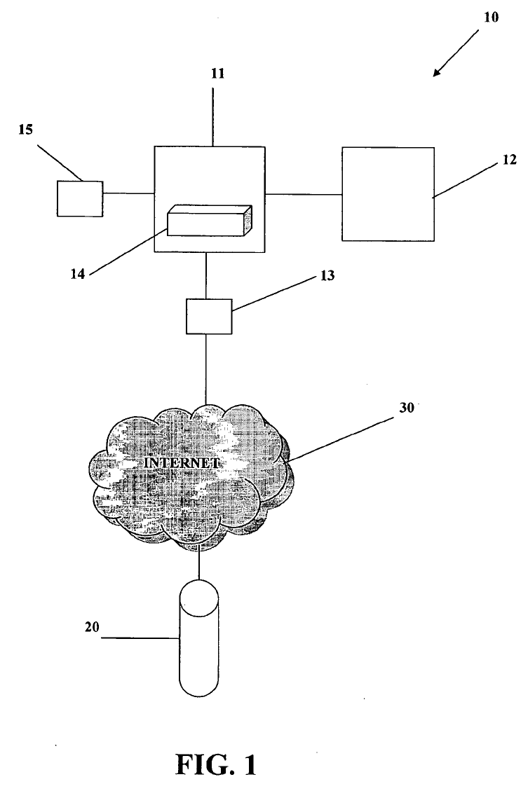

Referring now to the drawings, as shown in FIGS. 1-3, a system 10 and a method 100 are provided for extending the period of traditional patent protection, in accordance with the present invention. According to one embodiment of the invention, as shown in FIG. 1, at the core of the system is a programmable apparatus 11, e.g., an Intel Pentium-based, ISP equipped, conventional desktop computer, laptop or the like with Microsoft Windows based operating system, such being provided for implementing the method of the present invention, in general, and for housing programming for extending the period of patent protection, in particular. The system also has a display monitor 12, a communications modem 13, such as a conventional, Internet compatible modem, a central processing unit 14, and a conventional input device 15, e.g., keyboard, mouse, touchpad, conventional voice input device or the like.

The apparatus is desirably suitable for two-way communications with a server 20 by way of a 32-bit Wintel platform with a TCP/IP connection to the server. The server is preferably of a conventional type such as a 32-bit, platform independent, in JAVA for sending and receiving data packets over the Internet.

A communications network 30 links the apparatus to the server by traditional means including wire-based, wireless, fiber optic and other suitable connections through land-based, telephonic, wireless and/or satellite systems.

The fundamental components of the system arc considered well known in the art. Additional description and details regarding its operation are deemed unnecessary for illustrating the principles of the present invention.

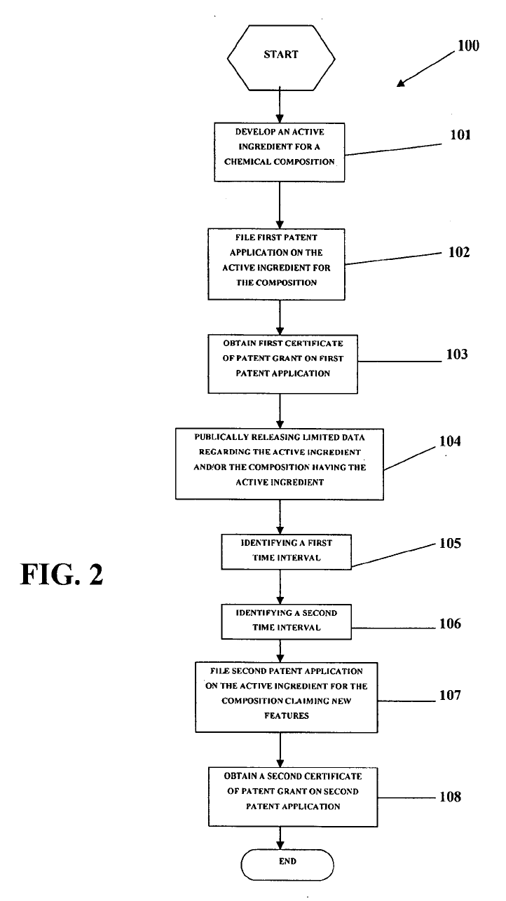

Turning to another aspect of the present invention, as shown generally in FIG. 2, method 100 is provided for extending the period of traditional patent protection. Initially, an active ingredient such Celecoxib for a chemical composition, preferably a pharmaceutical composition, e.g., ______, is developed 101 by a developer such as a research laboratory of a pharmaceutical company. An initial patent application is filed 102, such as by a registered patent attorney or agent, in a selected country, e.g., the United States of America, on behalf of the developer of the active ingredient. Preferably, filing is effected electronically using programmable apparatus 11 and conventional Internet filing services provided through the Electronic Filing Systems (EFS) of the United States Patent and Trademark Office Web site, www.uspto.gov, e.g., using electronic packaging and validation system software (ePAVE5.1).

The initial application is directed to the active ingredient for the chemical composition. An initial certificate of patent grant is then issued 103 on the active ingredient. Thereafter, limited data, e.g., product performance, medical treatments, warnings, side effects, test results or the like, relating to the active ingredient and/or the composition having the active ingredient is released publicly 104, such data being the only publicly available data on the active ingredient and/or the composition having the active ingredient.

Next, at least a first time interval during the product life of the active ingredient and/or the composition having the active ingredient is identified 105 which commences upon submission of the initial application directed to protection of the active ingredient and ends on the date that authorization is obtained from one of a group of government related regulatory authorities, e.g., the FDA of the United States Government, for marketing the active ingredient and/or the composition having the active ingredient. Any characteristic(s) of the active ingredient and/or the composition having the active ingredient being generally unknown by any person and/or entity other than the developer and those that may be legally bound by a conventional non-disclosure agreement.

Thereafter, but not necessarily in this order, at least a second time interval during the product life of the active ingredient and/or the composition having the active ingredient is identified 106. The second interval begins on the date that initial marketing of the active ingredient and/or the composition having the active ingredient commenced and ends upon expiration of the certificate of patent grant. As is understood by those skilled in the art, in view of the patent monopoly, there is no initiative during the second interval for one or more third party developers to independently produce and market the active ingredient and/or the composition having the active ingredient in competition with the developer.

Finally, before the end of either of the first and second time intervals, during which only the limited data regarding the composition having the active ingredient and/or the composition having the active ingredient is publicly available, a subsequent patent application is filed 107 in the same country as the initial application. The subsequent application has continuity of filing with respect to the initial application, has subject matter in common with the initial application, and is directed to newly appreciated properties or characteristics, such as the bioavailability of the drug, of the active ingredient. A subsequent certificate of grant is then obtained 108 on the subsequent patent application. Such practice, thereby, lawfully interferes, actively and/or constructively, with production and marketing of the active ingredient and/or the composition having the active ingredient by the one or more third party developers, which would otherwise occur upon expiration of the certificate of patent grant and the lawful patent monopoly granted thereby.

According to various aspects of the present invention, the second period is desirably identified only after marketing has begun, i.e., only after the subsequent application has been filed.

In an alternative embodiment of the invention, before the end of either of the first and second time intervals, the subsequent patent application is filed on behalf of the developer in the same country as the initial application, has continuity of filing with respect to common subject matter in the initial application, but contains new subject matter relating to the active ingredient. Such new subject matter constitutes one or more modifications, for instance, the rate of dissolution of the active ingredient, relating to the active ingredient and/or the composition having the active ingredient. A subsequent certificate of patent grant is then obtained on the subsequent application, thereby, lawfully interfering with the production and marketing of such active ingredient and/or composition having the active ingredient by the one or more third party developers, which would otherwise occur upon expiration of the certificate of patent grant and the lawful patent monopoly granted thereby.

Alternatively or concurrently, before the end of either of the first and second time intervals, again during which only the limited data regarding the active ingredient and/or the composition having the active ingredient is publicly available, a subsequent patent application is filed on behalf of the developer in the same country as the initial application. The subsequent application has continuity of filing with respect to common subject matter in the initial application, but contains new subject matter relating to the active ingredient. The new subject matter constitutes one or more new applications, e.g., preferably of medical conditions closely related and narrowly distinguished from the original known use of the drug, of the active ingredient. Thereafter, a subsequent certificate of patent grant is obtained on the subsequent application, thereby, lawfully interfering with the production and marketing of such active ingredient and/or composition having the active ingredient by the one or more third party developers, which would otherwise occur upon expiration of the certificate of patent grant and the lawful patent monopoly granted thereby.

Further in the alternative or concurrently with the foregoing, before the end of either of the first and second time intervals, a subsequent patent application is filed on behalf of the developer in the same country as the initial application. The subsequent application has continuity of filing with respect to common subject matter in the initial application, but contains new subject matter relating to the active ingredient. The new subject matter constitutes one or more methods of treatment using the active ingredient. Example methods include dosing information such as time of day to administer the drug. Last, a subsequent certificate of patent grant is obtained on the subsequent application, thereby, lawfully interfering with the production and marketing of such active ingredient and/or composition having the active ingredient by the one or more third party developers, which would otherwise occur upon expiration of the certificate of patent grant and the lawful patent monopoly granted thereby.

Also in the alternative or concurrently with the above, before the end of either of the first and second time intervals, a subsequent patent application is filed on behalf of the developer in the same country as the initial application, the subsequent application being based upon the initial application, having subject matter in common with the initial application, and having continuity of filing with respect to common subject matter in the initial application, but containing new subject matter relating to active ingredient. The new subject matter constitutes one or more commercially desirable chemical additives, such as a functional group of pharmaceutically acceptable excipients, e.g., fillers, or one or more chemical additives absent from the active ingredient, such as the absence of a specific excipient which was not necessarily included in the active ingredient initially, to the active ingredient. A subsequent certificate of patent grant is then obtained on the subsequent application, thereby, lawfully interfering with the production and marketing of such active ingredient and/or composition having the active ingredient by the one or more third party developers, which would otherwise occur upon expiration of the certificate of patent grant and the lawful patent monopoly granted thereby.

Another process, according to the present invention, similarly relates to a method for extending the period of traditional patent protection. This process also begins with the step of developing an active ingredient for a chemical composition. An initial patent application on the active ingredient is filed on behalf of the developer in a selected country. An initial certificate of patent grant on the active ingredient is then obtained.

Next, at least a first time interval during the product life of the active ingredient and/or the composition having the active ingredient is identified which commences upon submission of the initial application directed to protection of the active ingredient and ends on the date that authorization is obtained from one of a group of government related regulatory authorities for marketing the active ingredient and/or the composition having the active ingredient. The basis of the second application may be any feature related to, but believed by applicant to be novel and inventive over the first application. Such features include but are not limited to characteristic(s) of the active ingredient and/or the composition having the active ingredient being generally unknown by any person and/or entity other than the developer and those that may be legally bound by a conventional non-disclosure agreement.

At least a second time interval during the product life of the active ingredient and/or the composition having the active ingredient is then identified. The second interval begins on the date that initial marketing of the active ingredient and/or the composition having the active ingredient commenced and ends upon expiration of the certificate of patent grant. As is understood by those skilled in the art, in view of the patent monopoly, there is no initiative during the second interval for one or more third party developers to independently produce and market the composition in competition with the developer.

Finally, before the end of either of the first and second time intervals, during which only the chemical name of the active ingredient and/or the composition having the active ingredient is made publicly available by the developer, a subsequent patent application is filed in the same country as the initial application. The subsequent application is characterized by continuity of filing with respect to the initial application, has subject matter in common with the initial application, and is directed to newly appreciated properties or characteristics, such as the bioavailability of the drug, with respect to the active ingredient. Finally, a subsequent certificate of patent grant is obtained on the subsequent patent application. Such practice, thereby, lawfully interferes, actively and/or constructively, with production and marketing of the active ingredient and/or the composition having the active ingredient by the one or more third party developers, which would otherwise occur upon expiration of the certificate of patent grant and the lawful patent monopoly granted thereby. Notably, the developer typically refers to the chemical name of the active ingredient and/or the composition having the active ingredient rather than its generic name in order to hinder one or more third party developers from tracing the corresponding patent.

Again, in accordance with various aspects of the present invention, the second period is desirably identified only after marketing has begun, i.e., only after the subsequent application has been filed.

Alternatively, the new subject matter constitutes one or more modifications relating to the active ingredient. A subsequent certificate of patent grant is secured on the subsequent application, thereby, lawfully interfering with the production and marketing of such active ingredient and/or composition having the active ingredient by the one or more third party developers, which would otherwise occur upon expiration of the certificate of patent grant and the lawful patent monopoly granted thereby. Alternatively or concurrently, the new subject matter constitutes one or more new applications of the active ingredient, one or more methods of treatment using the active ingredient, and/or one or more commercially desirable chemical additives to such active ingredient. Once a certificate of patent grant is obtained for the subsequent patent(s), a lawful interference is created to interfere with the production and marketing of such active ingredients and/or compositions including the active ingredient by the one or more third party developers, which would otherwise occur upon expiration of the certificate of patent grant and the lawful patent monopoly granted thereby.

Yet another embodiment of the invention relates to a method of increasing the period of monopoly of a chemical composition. First, an active ingredient for the chemical composition is developed. Second, an initial patent application is filed in a selected country on behalf of the developer of the active ingredient, such application being directed to the active ingredient for the chemical composition. Third, a subsequent patent application is filed on the active ingredient in the selected country on behalf of the developer prior to marketing the active ingredient and/or the composition having the active ingredient as a product. In some embodiments, the subsequent application may be directed to an intrinsic characteristic of the active ingredient. In other embodiments, the subsequent application is directed to the instruction steps to the patient or health professional that are to accompany the product being marketed or in the prescribing information.

An additional embodiment of the invention concerns a method for increasing the period of a monopoly of a chemical composition, in which an active ingredient for the chemical composition is first developed, and then a plurality of patent applications is filed in a selected country on behalf of the developer of the active ingredient. Such applications are directed to a method of manufacturing the active ingredient by conventional techniques and the respective dosage forms of the active ingredient, each application describing only the generally used ingredients for manufacturing the active ingredient.

A further embodiment concerns a method for increasing the period of a monopoly of a chemical composition. An active ingredient for a chemical composition is developed and, subsequently, an initial patent application is filed in a selected country on behalf of the developer of the active ingredient. The application is directed to a formulation of the active ingredient not containing a selected ingredient that is considered unsuitable for the active ingredient.

Still another aspect of the invention is directed to a method for increasing the period of a monopoly of a chemical composition. Initially, a first form of an active ingredient for the chemical composition is developed. Next, a second form of the active ingredient for the chemical composition is developed by searching intensively for and developing a new polymorph, metaphase, allotrope or pseudo-polymorph thereof. An initial patent application is then filed in a selected country on behalf of the developer of the active ingredient, the initial application being directed to the first form of the active ingredient and describing at least one advantage of the first form. Finally, a subsequent patent application is filed in the selected country on behalf of the developer; the subsequent application covering the second form of the active ingredient and describing, at least speculatively, but preferably with at least preliminary empirical or theoretical support, an advantage of the second form.

In this regard, it is at least helpful, but generally not critical, for the advantage to be empirically determined and surprising. Such an advantage may conveniently be flagged by terminology such as “it has been surprisingly found” and variations thereof as known to persons of the art.

In a further embodiment, a method for increasing the period of a monopoly of a chemical composition is provided. The method comprising the steps of developing an active ingredient for the chemical composition, and filing a plurality of patent applications in a selected country on behalf of the developer of the active ingredient wherein the applications are directed to inclusion of a relatively small amount of one or more solvents selected from a range of common solvents, typically but not necessarily without restriction to solvents from among the solvents used in a selected synthesis route.

Still another embodiment concerns a method for increasing the period of a monopoly for a chemical composition by (i) developing at least one active ingredient for the chemical composition; (ii) filing an initial patent application in a selected country on behalf of the developer of the active ingredient, the application covering the active ingredient for the chemical composition; (iii) filing a subsequent patent application, based upon and having continuity of filing with the initial application, on the active ingredient, the subsequent application being directed to a newly discovered ingredient that was present in the active ingredient of the initial application but not identified in the initial application; (iv) obtaining an initial certificate of patent grant on the active ingredient that was the subject of the initial application; and (v) obtaining a subsequent certificate of patent grant on the active ingredient that was the subject of the subsequent application.

Alternatively, a method for increasing the period of a monopoly of a chemical composition comprises the steps of first developing an active ingredient for the chemical composition, then filing an initial patent application in a selected country on behalf of the developer of the active ingredient, such application being directed to patient instruction steps that are to accompany the active ingredient and/or the composition having the active ingredient when marketed as a product, and last, after marketing of the product has begun, filing one or a plurality of subsequent patent applications, based upon and having filing continuity with the initial application, each including instruction steps to either the patient or health professional regarding dosage.

Yet a further embodiment of the method for increasing the period of a monopoly of a chemical composition, comprises the steps of (i) developing an active ingredient for the chemical composition; (ii) filing an initial patent application in a selected country on behalf of the developer of the active ingredient, such application being directed to the active ingredient for the chemical composition; and (iii) filing a plurality of subsequent patent applications covering methods used to analyze the active ingredient and a final dosage form of the active ingredient, respectively. In a variant method, steps (ii) and (iii) above are replaced with a step (iia) such that the initial patent application is directed to the active ingredient and selected impurities for the chemical composition; and step (iiia) a plurality of subsequent patent applications are filed that cover additional impurities found in the active ingredient and a final dosage form of the active ingredient. Furthermore, in the alternative to step (iii) above, at least one subsequent patent application is filed covering a method of use of the active ingredient relating to a dosing regime registered with at least one of a group of government related regulatory agencies. According to still another alternative to method step (iii), at least one subsequent patent application is filed on at least one impurity found in the active ingredient and a final dosage form of the active ingredient and/or a method of identifying the impurity.

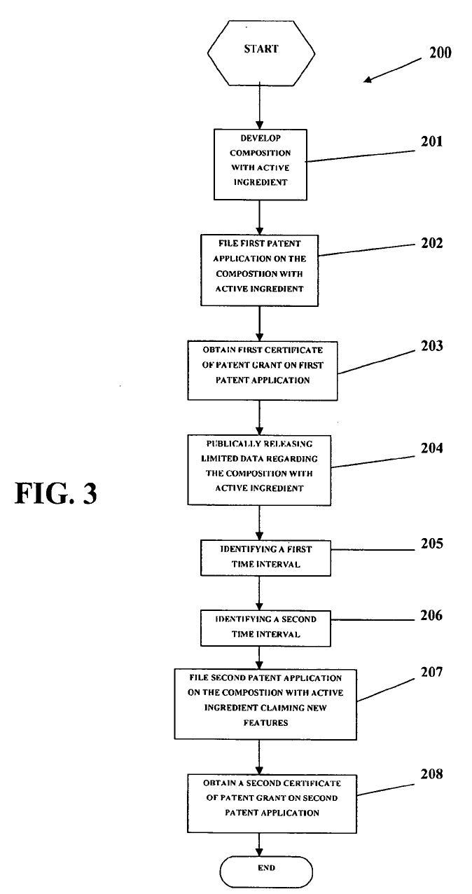

Referring now to another aspect of the invention, illustrated generally in FIG. 3, a method 200 is provided for extending the period of traditional patent protection. First, a chemical composition, preferably a pharmaceutical composition, e.g., ______, having an active ingredient such as Celecoxib is developed 201 by a developer such as a research laboratory of a pharmaceutical company. An initial patent application is filed 202, such as by a registered patent attorney or agent, in a selected country, e.g., the United States of America, on behalf of the developer of the composition. Preferably, filing is effected electronically using programmable apparatus 11 and conventional Internet filing services provided through the Electronic Filing Systems (EFS) of the United States Patent and Trademark Office Web site, www.uspto.gov, e.g., using electronic packaging and validation system software (ePAVE5.1).

The initial application relates to the composition having the active ingredient. An initial certificate of patent grant is then issued 203 on the composition including the active ingredient. Thereafter, limited data, e.g., data on product performance, medical treatments, warnings, side effects, test results or the like, concerning the composition having the active ingredient is released publicly 204, such data being the only publicly available data on the composition including the active ingredient.

Subsequently, at least a first time interval during the product life of the composition is identified 205 that commences upon submission of the initial application directed to protection of the active ingredient and ends on the date that authorization is obtained from one of a group of government related regulatory authorities, e.g., the FDA of the United States Government, for marketing the composition with the active ingredient. Any characteristic(s) of the composition having the active ingredient being generally unknown by any person and/or entity other than the developer and those that may be legally bound by a conventional non-disclosure agreement.

Next, but not necessarily in this order, at least a second time interval during the product life of the composition is identified 206. The second interval commences on the date initial marketing of the composition began and ends upon expiration of the certificate of patent grant. As is understood by those skilled in the art, in view of the patent monopoly, there is no initiative during the second interval for one or more third party developers to independently produce and market the composition in competition with the developer.

Finally, before the end of either of the first and second time intervals, during which only the limited data regarding the composition having the active ingredient is publicly available, a subsequent patent application is filed 207 in the same country as the initial application. The subsequent application has continuity of filing with respect to the initial application, has subject matter in common with the initial application, and is directed to newly appreciated properties or characteristics, such as the bioavailability of the drug, of the composition including the active ingredient. A subsequent certificate of grant is then obtained 208 on the subsequent patent application. Such practice, thereby, lawfully interferes, actively and/or constructively, with production and marketing of the composition including the active ingredient by the one or more third party developers, which would otherwise occur upon expiration of the certificate of patent grant and the lawful patent monopoly granted thereby.

In an alternative embodiment of the invention, prior to the end of either of the first and second time intervals, the subsequent patent application is filed on behalf of the developer in the same country as the initial application, has continuity of filing with respect to common subject matter in the initial application, but contains new subject matter relating to the composition having the active ingredient. Such new subject matter constitutes one or more modifications relating to the composition having the active ingredient, such as, by way of non-limiting example, the rate of dissolution of the pharmaceutical composition and the like. A subsequent certificate of patent grant is then obtained on the subsequent application so as to lawfully interfere with the production and marketing of such composition including the active ingredient by the one or more third party developers, which would otherwise occur upon expiration of the certificate of patent grant and the lawful patent monopoly granted thereby.

Alternatively or concurrently, before the end of either of the first and second time intervals, again during which only the limited data regarding the composition having the active ingredient is publicly available, a subsequent patent application is filed on behalf of the developer in the same country as the initial application. The subsequent application has continuity of filing with respect to common subject matter in the initial application, but contains new subject matter relating to the composition having the active ingredient. The new subject matter constitutes one or more new applications of the composition including the active ingredient, e.g., desirably of medical conditions closely related to and narrowly distinguished from the original known use of the drug. Thereafter, a subsequent certificate of patent grant is obtained on the subsequent application so as to lawfully interfere with the production and marketing of such composition including the active ingredient by the one or more third party developers, which would otherwise occur upon expiration of the certificate of patent grant and the lawful patent monopoly granted thereby.

Further alternatively to or concurrently with the foregoing, before the end of either of the first or second time intervals, a subsequent patent application is filed on behalf of the developer in the same country as the initial application. The subsequent application has continuity of filing with respect to common subject matter in the initial application, but contains new subject matter relating to the composition having the active ingredient. The new subject matter constitutes one or more methods of treatment using the composition including the active ingredient. Exemplary methods include dosing information such as time of day to administer the drug. Last, a subsequent certificate of patent grant is obtained on the subsequent application, thereby, lawfully interfering with the production and marketing of such composition including the active ingredient by the one or more third party developers, which would otherwise occur upon expiration of the certificate of patent grant and the lawful patent monopoly granted thereby.

Also in the alternative or concurrently with the above, prior to the end of either of the first and second time intervals, a subsequent patent application is filed on behalf of the developer in the same country as the initial application, the subsequent application being based on the initial application, having subject matter in common with the initial application, and having continuity of filing with respect to common subject matter in the initial application, but containing new subject matter relating to the composition having the active ingredient. The new subject matter constitutes one or more commercially desirable chemical additives, such as a functional group of pharmaceutically acceptable excipients, e.g., fillers, or one or more absent chemical additives absent from the pharmaceutical composition, such as the absence of a specific excipient that was not necessarily included in the composition initially, to the composition including the active ingredient. A subsequent certificate of patent grant is then obtained on the subsequent application so as to, lawfully interfere with production and marketing of such composition including the active ingredient by the one or more third party developers, which would otherwise occur upon expiration of the certificate of patent grant and the lawful patent monopoly granted thereby.

Another method, according to the present invention, likewise relates to a method for extending the period of traditional patent protection. This process begins similarly with the step of developing a pharmaceutical composition having an active ingredient. An initial patent application on the composition having the active ingredient is filed on behalf of the developer in a selected country. An initial certificate of patent grant on the composition including the active ingredient is then obtained.

Next, at least a first time interval during the product life of the composition is identified that begins upon submission of the initial application relating to protection of the active ingredient and ends on the date that authorization is obtained from one of a group of government related regulatory authorities for marketing the composition with the active ingredient. Any characteristic(s) of the composition having the active ingredient that is generally unknown to entities such as, but not limited to persons, other than the developer and those that may be legally bound by a conventional non-disclosure agreement NDA.

At least a second time interval during the product life of the composition is identified. The second interval begins on the date that initial marketing of the composition commenced and ends upon expiration of the certificate of patent grant. As is understood by those skilled in the art, in view of the patent monopoly, there is no initiative during the second interval for one or more third party developers to independently produce and market the composition in competition with the developer.

Then, before the end of either of the first and second time intervals, during which only the chemical name of the composition having the active ingredient is made publicly available by the developer, a subsequent patent application is filed in the same country as the initial application. The subsequent application has continuity of filing with respect to the initial application, has subject matter in common with the initial application, and is directed to newly appreciated properties or characteristics, such as the bioavailability of the drug, with respect to the composition including the active ingredient. Finally, a subsequent certificate of patent grant is obtained on the subsequent patent application. An objective of this practice is to lawfully interfere, actively and/or constructively, with production and marketing of the composition including the active ingredient by the one or more third party developers, which would otherwise occur upon expiration of the certificate of patent grant and the lawful patent monopoly granted thereby. Notably, as understood, the developer typically refers to an IUPAC or chemical name of the composition rather than its branded or generic name in order to hinder one or more third party developers from tracing the corresponding patent.

Alternatively, the new subject matter constitutes one or more modifications relating to the composition including the active ingredient. A subsequent certificate of patent grant is secured on the subsequent application, thereby, lawfully interfering with production and marketing of such composition including the active ingredient by the one or more third party developers, which would otherwise occur upon expiration of the certificate of patent grant and the lawful patent monopoly granted thereby. Alternatively or concurrently, the new subject matter constitutes one or more new applications of the composition including the active ingredient, one or more methods of treatment using the composition including the active ingredient, and/or one or more commercially desirable chemical additives to such composition including the active ingredient. Once a subsequent certificate of patent grant is obtained, such, thereby, individually or collectively, lawfully interferes with the production and marketing of such composition including the active ingredient by the one or more third party developers, which would otherwise occur upon expiration of the certificate of patent grant and the lawful patent monopoly granted thereby.

Yet another embodiment of the invention relates to a method of increasing the period of a monopoly of a chemical composition. First, a chemical composition having an active ingredient is developed. Second, an initial patent application is filed in a selected country on behalf of the developer of the composition. Such application is directed to the chemical composition having the active ingredient. Third, prior to marketing the composition having the active ingredient as a product, a subsequent patent application is filed on the composition having the active ingredient in the selected country on behalf of the developer, the subsequent application being directed to an intrinsic characteristic of the composition having the active ingredient. Alternatively, the subsequent patent application is directed to the instruction steps to the patient or health professional that are to accompany the product being marketed or in the prescribing information.

An additional embodiment of the invention concerns a method for increasing the period of a monopoly of a chemical composition having an active ingredient, in which the chemical composition having the active ingredient is first developed, and then a plurality of patent applications are filed in a selected country on behalf of the developer of the composition. Such applications are directed to a method of manufacturing the composition having the active ingredient by conventional techniques and the respective dosage forms of the composition having the active ingredient. Preferably, each application describes only the generally used ingredients for manufacturing the composition having the active ingredient.

A further embodiment concerns a method for increasing the period of a monopoly of a chemical composition having an active ingredient. The chemical composition having the chemical composition is first developed and, subsequently, an initial patent application is filed in a selected country on behalf of the developer of the composition. This embodiment is particularly characterized by the application being directed to a formulation of the composition having the active ingredient not containing a selected ingredient that is considered unsuitable for the composition having the active ingredient.

Still another aspect of the invention is directed to a method for increasing the period of a monopoly of a chemical composition having an active ingredient. Initially, a first form of the chemical composition having the active ingredient is developed. Next, a second form of the chemical composition having the active ingredient is developed by searching intensively for and developing a new or at least hitherto uncharacterized physical form, such as an allotrope, metaphase, polymorph or pseudo-polymorph thereof. An initial patent application is filed in a selected country on behalf of the developer of the composition, the initial application being directed to the first form of the composition and describing at least one speculated advantage of the first form. Preferably the hypothesized advantage is backed by some theoretical or empirical support or calculation. Finally, a subsequent patent application is filed in the selected country on behalf of the developer, the subsequent application covering the second form of the composition and describing at least one advantage of the second form.

Alternatively, a method is provided for increasing the period of a monopoly of a chemical composition having an active ingredient, which comprises the steps of developing the chemical composition having the active ingredient, and filing a plurality of patent applications in a selected country on behalf of the developer of the composition. Such applications are directed to a relatively small amount of solvate within a range of common solvents without restricting the solvents to being among the solvents used in a selected route of synthesis.

Another alternative embodiment relates to a method for increasing the period of a monopoly of a chemical composition having active ingredients. First, at least two active ingredients for the chemical composition are developed. Second, an initial patent application is filed in a selected country on behalf of the developer of the composition. Such application covers simultaneous use of a combination or collocation of the at least two active ingredients of the chemical composition, the simultaneous use having a synergistic effect but disclosing in the initial application specification a minimal of data in support of such effect.

Still another embodiment concerns a method for increasing the period of a monopoly of a chemical composition having an active ingredient, which comprises the steps of(i) developing a chemical composition having at least one active ingredient; (ii) filing an initial patent application in a selected country on behalf of the developer of the composition, the application covering the chemical composition having the at least one active ingredient; (iii) filing a subsequent patent application, based upon and having continuity of filing with the initial application, on the active ingredient, the subsequent application being directed to a newly discovered ingredient that was present in the composition of the initial application but was not identified in the initial application; (iv) obtaining an initial certificate of patent grant on the composition that was the is subject of the initial application; and (v) obtaining a subsequent certificate of patent grant on the composition that was the subject of the subsequent application.

Alternatively, a method is provided for increasing the period of a monopoly of a chemical composition having an active ingredient. The method comprises the steps of first developing the chemical composition having the active ingredient, then filing an initial patent application in a selected country on behalf of the developer of the composition, such application being directed to patient instruction steps that are to accompany the composition having the active ingredient when marketed as a product, and last after marketing of the product has begun, filing a plurality of subsequent patent applications, based upon and having filing continuity with the initial application, each being directed to the additional patient or health professional instruction steps inherent in or that should have been disclosed in the instruction steps of the initial application.

Yet a further embodiment of the method for increasing the period of a monopoly of a chemical composition having an active ingredient comprises the steps of (i) developing the chemical composition having the active ingredient; (ii) filing an initial patent application in a selected country on behalf of the developer of the composition, such application being directed to the chemical composition having the active ingredient; and (iii) filing a plurality of subsequent patent applications covering methods used to analyze the composition having the active ingredient and a final dosage form of the composition having the active ingredient. Alternatively to steps (ii) and (iii) above, in step (ii) the initial patent application is directed to the composition having the active ingredient and selected impurities for the composition; and in step (iii) a plurality of subsequent patent applications are filed that cover additional impurities found in the composition having the active ingredient and a final dosage form of the composition having the active ingredient. Further in the alternative to step (iii) above, at least one subsequent patent application is filed covering a method of use of the composition having the active ingredient relating to a dosing regimen registered with at least one of a group of government related regulatory agencies. According to still another alternative to method step (iii), at least one subsequent patent application is filed on at least one impurity found in the composition having the active ingredient and a final dosage form of the composition having the active ingredient and/or a method of identifying the impurity.

While the present invention has been described with reference to a subsequent patent application, the subject matter of which is considered by the developer to be novel and nonobvious at the time of filing, it is understood by those skilled in the art that such requirements of novelty and non-obviousness are not needed, according to the principles of the present invention.

The following are examples of tactics and methods used for extending the period of traditional patent protection and otherwise blocking entry of competitors into the market of a pharmaceutical composition having an active ingredient.

### EXAMPLE I

A few weeks prior to the developer's launching of a pharmaceutical product on the market, the developer files a subsequent patent application on a composition that contains a second active ingredient, such second active ingredient being present in a third party developer's pharmaceutical product, and which exhibits some intrinsic characteristics of a first active ingredient of the developer's composition containing the active ingredient. Examples of such intrinsic characteristics include one or more of the following: terminal half-life, time to reach maximum concentration in a body fluid, maximum concentration in a body fluid, ways of metabolizing, means for elimination from the body, bioavailability, therapeutic administrable amount of the active ingredient, and dosing regimen. The value of each intrinsic characteristic is preferably defined within a maximum acceptable range of safety and effectiveness.

### EXAMPLE II

A few weeks prior to the developer's launching of a pharmaceutical product on the market, the developer files a subsequent patent application on one or more methods of treatment or other information regarding use of the composition containing the first active ingredient of the developer's composition. The information may include instructions to the patient as appear in the approved patient leaflet for the product, drug-drug interaction information, drug-food interaction information, adverse effect of the product as well as product warnings.

### EXAMPLE III

In the event that amendments are required to be made to a patient information leaflet or prescribing information for a pharmaceutical product while the product is on the market, a subsequent patent application is filed by the developer on the new information in the patient leaflet or prescribing information. This forces a third party developer having a competitive product to withdraw its product from the market due to its inability to market such product with an accompanied up-to-date patient leaflet as covered by the developer's patent application.

### EXAMPLE IV

Initially, the developer conducts extensive research and development, searching intensively for new polymorphs or pseudo-polymorphs using modern techniques of crystallization screening. After finding a new polymorph or pseudo-polyrnorph and determining its advantage(s) on the known polymorphs or pseudo-polymorphs, the developer files an initial patent application for the same. Such advantage(s) include, but are not limited to, one or more of the following chemical, physical, commercial or other characteristics: lower viscosity, lower storage volume requirements, improved stability, better particle size or shape, lessened toxicity. The objective of the developer's patent application is to solve a problem known in the prior art. During prosecution of the patent application, the developer faces a rejection of its application by a Patent Examiner for obviousness. In responding to the rejection, the developer retains an expert and provides the expert with incomplete or incorrect information from the prior art, which leads the expert to conclude that the solution to the problem set forth in the application is not obvious. The expert's inability to solve the problem in the art, which is set forth in an affidavit to the Patent Office, proves or at least substantiates nonobviousness of the solution disclosed in the patent application. Alternatively, two or more experts are approached with the complete information from the prior art. One expert solves the problem readily, while another cannot solve the problem. The expert who cannot solve the problem is chosen to provide an affidavit as to nonobviousness.

### EXAMPLE V

A developer files several patent applications on different synthesis routes for manufacturing the active ingredient(s) of a pharmaceutical composition. The claims in each patent application are drafted broadly to prevent third party developers from designing around any certificate of patent grant that issues thereon, regardless of whether the patent application third party developer obtained such active ingredient in a different manner, which is not covered by the patent application.

### EXAMPLE VI

The developer conducts extensive research and development, searching intensively for a pharmaceutical excipient, which cannot be incorporated in the final dosage form with an active ingredient of a first pharmaceutical composition. Examples include oxidative materials which would destroy a portion of the active ingredient. A patent application is nevertheless filed by the developer on a final dosage form which does not contain the excipient.

### EXAMPLE VII

A developer files several patent applications on an active ingredient of a pharmaceutical composition having a relatively small amount of solvate within a range of common solvents. The solvates are optionally of solvents that are not necessarily used :n the synthesis routes used to manufacture the active ingredients. Preferably, the solvate is of a toxic or hazardous solvent and of a solvent not normally used in pharmaceutical preparations.

### EXAMPLE VIII

A developer files a patent application on each and every impurity found in an active ingredient of a pharmaceutical composition or in the final dosage form. It is preferred that the application include methods of identification of the impurity.

### EXAMPLE IX

Initially, the developer conducts extensive research and development, searching intensively for new polymorphs or pseudo-polymorphs using modern techniques of crystalIization screening. After finding a new polymorph or pseudo-polymorph and determining its advantage(s) on the known polymorphs or pseudo-polymorphs, but for which no known method is disclosed for manufacturing them, the developer files an initial patent application for the same. Such advantage(s) include, but are not limited to, one or more of the following chemical, physical, commercial or other characteristics: lower viscosity, lower storage volume requirements, improved stability, better particle size or shape, lessened toxicity. The objective of the developer's patent application is to solve a problem known in the prior art. During prosecution of the initial application, after an initial certificate of patent grant on the composition containing the active ingredient with polymorphs or pseudo-polymorphs, or after expiration of the initial certificate of patent grant, the developer files a subsequent patent application directed to a method of manufacturing the composition including the active ingredient with the polymorph or pseudo-polymorph, and obtains a subsequent certificate of patent grant for the same.

Although the present invention is shown and described with respect to drugs and other pharmaceutical compositions, its application to other chemical compositions outside of the pharmaceutical industry is within the scope and spirit of the present invention.

Overall, the present invention beneficially delays the introduction of a competitor's product into the market by legally extending the duration of protection afforded by a patent. It also demonstrates that flaws inherent in the patent system that allow developers to engage in commercial practices that operate to extend the monopolies of patents in contravention of the patent laws. In this manner, the developer can use the high earnings achieved through prolonging a patent monopoly on a pharmaceutical composition to demonstrate high earnings and increased profitability and, in turn, facilitate payment of dividends to the developer's common stock holders.

In the following, the patent claims will be given, and the various details of the invention can show variation within the scope of the inventive ideadefined in the claims and differ even to a considerable extent from the details stated above by way of example only. As such, the examples provided above are not meant to be exclusive and many other variations of the present invention would be obvious to those skilled in the art, and are contemplated to be within the scope of the appended claims.

Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

I claim:

1. A method for extending the period of traditional patent protection, comprising the steps of:
developing an active ingredient for a chemical composition;
filing an initial patent application in a selected country on behalf of the developer of the active ingredient, such application being directed to the active ingredient for the chemical composition and optionally claiming polymorphs and pseudo-polymorphs of the active ingredient or composition thereof;
obtaining an initial certificate of patent grant on the active ingredient;
releasing limited data from the developer relating to the active ingredient and/or the composition having the active ingredient, such data being the only publicly available data on the active ingredient and/or the composition having the active ingredient;
identifying at least a first time interval during the product life of the active ingredient and/or the composition having the active ingredient which commences upon submission of the initial application directed to protection of the active ingredient and ends on the date that authorization is obtained from one of a group of government related regulatory authorities for marketing the active ingredient and/or the composition having the active ingredient, any characteristic(s) of the active ingredient and/or the composition having the active ingredient being generally unknown by any person and/or entity other than the developer and those that may be legally bound by a conventional non-disclosure agreement;
identifying at least a second time interval during the product life of the active ingredient and/or the composition having the active ingredient, the second interval beginning on the date that initial marketing of the active ingredient and/or the composition having the active ingredient commenced and ending upon expiration of the certificate of patent grant, there being no initiative during the second interval, in view of the patent monopoly, for one or more third party developers to independently produce and market the active ingredient and/or the composition having the active ingredient in competition with the developer;
before the end of either of the first and second time intervals during which only the limited data regarding the active ingredient and/or the composition having the active ingredient is publicly available, filing at least a first subsequent patent application on behalf of the developer in the same country as the initial application, the subsequent application or applications being based upon the initial application, having subject matter in common with the initial application, and having continuity of filing with respect to the initial application; obtaining a subsequent certificate of patent grant on the subsequent application, thereby lawfully interfering with the production and marketing of a composition comprising the active ingredient by a third party developer, which would otherwise be lawful upon expiration of the certificate of the patent grant and the lawful patent monopoly granted thereby.

2. The method of claim 1, wherein the at least a first subsequent application is directed to protecting at least one of the following list:
(a) at least one newly appreciated property or characteristic of the active ingredient;
(b) at least one modification relating to the active ingredient;
(c) at least novel application of the active ingredient;
(d) at least one method of treatment using the active ingredient;
(e) at least one commercially desirable chemical additive to the active ingredient;
(f) at least one intrinsic characteristic of the active ingredient;
(g) at least one instruction to a patient;
(h) at least one instruction to a health professional;
(i) at least one method of manufacturing the active ingredient by a conventional technique;
(j) disclosing at least one dosage form of the active ingredient;
(k) one or more formulation of the active ingredient not containing a selected inactive ingredient;
(l) one or more polymorph, pseudopolymorph, phase, metaphase or allotrope of the active ingredient with a description of at least one claimed advantage of the claimed chemical form;
(m) addition of a relatively small amount of at least one solvent selected from a given range of common solvents, said at least one solvent not being restricted to the solvents used in a synthesis route supported by specification of application;
(n) one or more formulations combining at least two active ingredients, the simultaneous use having a claimed synergistic effect;
(o) a newly discovered ingredient that was present in the active ingredient of the initial application but was not identified therewithin;
(p) one or more methods used to analyze the active ingredient or a final dosage form thereof;
(q) an at least a first impurity found in the active ingredient or a final dosage form thereof;
(r) at least one method of use of the active ingredient or composition including the activea ingredient;
(s) at least one method of manufacturing the active ingredient as a polymorph or pseudo-polymorph or amorphous state,
and (t) at least one composition containing the active ingredient.

3. A method for extending the period of traditional patent protection for a chemical composition, comprising the steps of:
(i) developing a chemical composition comprising at least an active ingredient;
(ii) filing an initial patent application in a selected country on behalf of a developer of the active ingredient, the application being directed to the chemical composition;
(iii) obtaining an initial certificate of patent grant on the chemical composition;
(iv) identifying at least a first characteristic of the chemical composition generally unknown to entities other than the developer or parties bound to the developer by a non-disclosure agreement; the identification occurring during at least a first time interval of the product life of the active ingredient commencing upon submission of the initial application and ending on a date on which authorization is obtained from one of a group of government related regulatory authorities for marketing the chemical composition;
(v) identifying at least a second time interval during the product life of the chemical composition, the second interval beginning on the date that initial marketing of chemical composition commenced and ending upon expiration of the certificate of patent grant, there being no initiative during the second interval, in view of the patent monopoly, for one or more third party developers to independently exploit the chemical composition in competition with the developer before the end of the first or second time intervals during which time the chemical composition is made publicly available by the developer,
(w) filing on behalf of the developer in the same country as the initial application at least one subsequent patent application based upon the initial application including subject matter in common with the initial application, and having continuity of filing with respect to the initial application the subsequent application being directed to a feature not detailed in the initial application, and
(x) obtaining a subsequent certificate of patent grant on the subsequent application, thereby, lawfully interfering with the production and marketing of chemical compositions including the active ingredient by the one or more third party developers, otherwise allowable upon expiration of the certificate of patent grant and the lawful patent monopoly granted thereby.

4. The method of claim 3, the feature being least selected from the list comprising:
(a) a newly appreciated property of the chemical composition;
(b) a characteristic of the chemical composition;
(c) a modification relating to the active ingredient;
(d) a new application of the active ingredient;
(e) a method of treatment using the active ingredient;
(f) at least a first commercially desirable chemical additive to the active ingredient;
(g) at least one intrinsic characteristic of the active ingredient;
(h) at least one instruction to a patient;
(i) at least one instructions to a health professional;
(j) at least one method of manufacturing the active ingredient by conventional techniques;
(k) a dosage form of the active ingredient;
(l) at least a first formulation of the active ingredient not containing a selected inactive ingredient;
(m) at least chemical form of the active ingredient not described in the initial application and a description of at least one advantage of the claimed chemical form;
(n) a relatively small amount of solvent selected from a range of common solvents not restricted to a selected synthesis route supported in first application;
(o) at least one formulation combining a plurality of active ingredients hypothesized as having a synergistic effect:
(p) a newly discovered ingredient, present among ingredients of preparations developed by the developer but not identified in the initial application;
(q) at least one method used to analyze the active ingredient;
(r) at least one method used to analyze a final dosage form comprising the active ingredient;
(s) at least one impurity of the chemical composition;
(t) at least one method of using the chemical composition;
(u) at least one method of manufacturing the active ingredient in a novel form selected from the list of: polymorphs, pseudo-polymorph, amorphous states and metaphases;

5. The method of claim 3 wherein the step of obtaining an initial certificate of patent grant on the active ingredient includes describing at least a first polymorph, pseudo-polymorph, allotrope, amorphous state, metastable state or nanocrystal.

6. A system for lawfully increasing the period of a patent monopoly of active ingredient for a chemical composition, comprising: a programmable apparatus including a central processing unit, a data input device, a random access memory, a read only memory a display monitor for visual illustration of the method, an Internet compatible communications modem for data communication with the Internet with a server for sending and receiving data packets to the programmable apparatus and a communications network for linking the apparatus to the server the programmable apparatus being programmed for word processing, wherein the programmable apparatus is usable for preparation of a first patent application and a second patent application, the system allowing online filing of the patent applications with a Patent Office selected from the list comprising domestic, foreign national, regional and international patent offices and for extending the period of patent protection obtained by filing a second patent application claiming priority from the first patent application.
